(19) United States
(12) Patent Application Publication
(10) Pub. No.: US 2023/0319770 A1
(43) Pub. Date: Oct. 5, 2023

(54) DECENTRALIZED POSITIONING PROCEDURES USING A SIDELINK INTERFACE

(71) Applicant: MEDIATEK INC., Hsinchu (TW)

(72) Inventors: Nathan Edward TENNY, San Jose, CA (US); Chiao-Yao CHUANG, Hsinchu (TW)

(73) Assignee: MEDIATEK INC., Hsinchu (TW)

(21) Appl. No.: 18/176,901

(22) Filed: Mar. 1, 2023

Related U.S. Application Data
(60) Provisional application No. 63/326,331, filed on Apr. 1, 2022.

(51) Int. Cl. H04W 64/00; H04W 8/22

(52) U.S. Cl. CPC H04W 64/00; H04W 8/22

(57) ABSTRACT

In a sidelink positioning method, a target UE and/or one or more peer UEs may transmit and/or measure reference signals on a sidelink interface. The target UE may determine its own transmission configuration for such reference signals, potentially taking into account the measurement capabilities of one or more peer UEs. The target UE may request a transmission configuration for such reference signals from one or more peer UEs. The peer UEs may determine their own transmission configuration(s) for the reference signals, potentially taking into account any request received from the target UE and/or the measurement capabilities of the target UE. The capability information, reference signal configuration information, and measurement results may be exchanged among the UEs. Related positioning protocols may be carried over transport layers of the sidelink interface.

### INCORPORATION BY REFERENCE

This present application claims the benefit of U.S. Provisional Application No. 63/326,331, “Decentralized Positioning Procedures Using a Sidelink Interface” filed on Apr. 1, 2022, which is incorporated herein by reference in its entirety.

### TECHNICAL FIELD

The present disclosure relates to wireless communications, and specifically to methods of determining the location of one device among a plurality of devices communicating via a direct device-to-device interface.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In conventional positioning using a Uu interface between a mobile device and a cellular network, a network node acts as a positioning server and controls positioning operations, including configurations of the device and network nodes, delivery of measurements, selection of a positioning method, and the like. The positioning server may also function as a position calculation entity (PCE). Alternatively or additionally, the mobile device may function as a PCE.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method of positioning a first user equipment (UE) is provided. The first UE transmits, on a sidelink interface to at least a second UE, a first message including a request for a requested reference signal configuration. The first UE receives, on the sidelink interface from the second UE, a second message including a transmitted reference signal configuration. The first UE measures a reference signal based on the transmitted reference signal configuration to produce at least one measurement result. The first UE delivers the at least one measurement result to a position calculation entity (PCE).

In another aspect of the disclosure, another method of positioning a first UE is provided. The first UE transmits, on a sidelink interface to at least a second UE, a first message requesting a measurement of a reference signal corresponding to a transmitted reference signal configuration. The first UE transmits, on the sidelink interface, the reference signal according to the transmitted reference signal configuration. The first UE receives, on the sidelink interface from at least the second UE, a second message including at least one measurement result of the reference signal corresponding to the transmitted reference signal configuration. The first UE delivers the at least one measurement result to a PCE.

In another aspect of the disclosure, a method of obtaining, by a first UE, positioning capabilities of a second UE is provided. The first UE transmits, on a sidelink interface to the second UE, a first message including a request for positioning capabilities of the second UE. The first UE receives, on the sidelink interface from the second UE, a second message including a description of at least a subset of the positioning capabilities of the second UE.

In yet another aspect of the disclosure, a further method of positioning a first UE is provided. The first UE transmits, on the sidelink interface to at least a second UE, a first message including a request for a description of a first transmitted reference signal configuration. The first UE transmits, on the sidelink interface to the at least a second UE, a second message including a request for measurement of a reference signal corresponding to a second transmitted reference signal configuration. The first UE receives, on the sidelink interface from the second UE, a third message including the description of the first transmitted reference signal configuration. The first UE measures a reference signal corresponding to the first transmitted reference signal configuration to produce first measurement results. The first UE transmits, on the sidelink interface, reference signals according to the second reference signal configuration. The first UE receives, on the sidelink interface from the second UE, a fourth message including second measurement results of the reference signal corresponding to the second transmitted reference signal configuration. The first UE delivers the first measurement results and the second measurement results to a PCE.

To the accomplishment of the foregoing and related ends, the one or more aspects include the features hereinafter described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Various embodiments of this disclosure that are proposed as examples will be described in detail with reference to the following figures, wherein like numerals reference like elements, and wherein:

FIG. 1 is a diagram illustrating a population of user equipments (UEs) communicating on a sidelink interface according to embodiments of the disclosure.

FIG. 2 is a diagram illustrating exemplary protocol stacks for transporting positioning protocols according to embodiments of the disclosure.

FIG. 3 illustrates an example of a positioning operation corresponding to but distinct from downlink time difference of arrival (DL-TDOA) using LTE Positioning Protocol (LPP) according to embodiments of the disclosure.

FIG. 4 illustrates an example of a positioning operation corresponding to but distinct from DL-TDOA using NR Positioning Protocol A (NRPPa) according to embodiments of the disclosure.

FIG. 5 illustrates an example of a positioning operation corresponding to but distinct from uplink time difference of arrival (UL-TDOA) using NRPPa according to embodiments of the disclosure.

FIG. 6 illustrates an example of a positioning operation corresponding to but distinct from UL-TDOA using LPP according to embodiments of the disclosure.

FIG. 7 illustrates a first example of an exchange of positioning capabilities on a sidelink interface in support of a positioning operation corresponding to but different from DL-TDOA using LPP, according to embodiments of the disclosure.

FIG. 8 illustrates a second example of an exchange of positioning capabilities on a sidelink interface in support of a positioning operation corresponding to but different from UL-TDOA using NRPPa, according to embodiments of the disclosure.

FIGS. 9A-9B illustrate an example of multiple round trip time (multi-RTT) positioning on a sidelink interface according to embodiments of the disclosure.

FIG. 10 shows an apparatus according to embodiments of the disclosure.

### DETAILED DESCRIPTION OF EMBODIMENTS

The detailed description set forth below in connection with the appended drawings is intended as a description of various configurations and is not intended to represent the only configurations in which the concepts described herein may be practiced. The detailed description includes specific details for the purpose of providing an understanding of various concepts. However, these concepts may be practiced without these specific details. In some instances, structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

In some embodiments, when positioning is contemplated in the context of direct device-to-device communication, there may be no entity in a role to function as a positioning server, and a decentralised set of procedures may be necessary to coordinate positioning operations among a plurality of devices.

In some embodiments, a device operating on a sidelink interface may be able to transmit and/or receive reference signals on the sidelink interface, such as sidelink positioning reference signals (SL-PRS). The SL-PRS may be transmitted on the sidelink interface by various mechanisms, including, for instance, transmission on reserved physical radio resources, transmission on a shared channel, and the like. The device may be able to measure one or more SL-PRS transmissions to obtain various types of measurement results, including, for instance, timing information, reference signal received power (RSRP), reference signal received quality (RSRQ), angle of arrival of the SL-PRS at the device, and the like. Different devices operating on the sidelink interface may have different capabilities for transmission and/or measurement of reference signals. Diverse algorithms may be employed to determine a location estimate of a target device. The location estimate can be determined from measurements taken by the target device on SL-PRS transmitted by one or more peer devices, measurements taken by one or more peer devices on SL-PRS transmitted by the target device, or a combination thereof. These algorithms may be considered as functions of a Positioning Calculation Entity (PCE), which may be instantiated in the target device, in a peer device, in a network node, and the like.

In some embodiments, the sidelink interface may be able to support transmission in any or all of a broadcast mode (that is, a transmission is sent to any UE that can hear it), a multicast mode (also referred to as a groupcast mode) (that is, a transmission is addressed to a group of UEs associated with a multicast identifier), and a unicast mode (that is, a transmission is directed to a specific UE). Transmission in these modes may be combined in a single procedure; for instance, a first UE may send a first message by broadcast or multicast, receive a second message from a second UE by unicast, and send a third message to the second UE by unicast.

In various embodiments, positioning protocols can support exchanges of capability information, reference signal configuration information, measurement results, and other information. This information may be required to support positioning operations. In some embodiments, these positioning protocols may use message formats similar to those used in related positioning protocols, such as the LTE Positioning Protocol (LPP), NR Positioning Protocol A (NRPPa), LPP extensions (LPPe), the radio resource control (RRC) protocol of Universal Mobile Telecommunications System (UMTS), Radio Resource Location services Protocol (RRLP), and the like. One or more messages of one or more such protocols may be adapted as described herein for use on the sidelink interface. For example, messages can be encapsulated in a lower-layer protocol used on the sidelink interface. As an example, messages of the LPP protocol and/or the NRPPa protocol may be encapsulated in a PC5 signalling (PC5-S) protocol or a PC5 radio resource control (PC5-RRC) protocol, which can be carried over the transport layers defined for the sidelink interface.

In device-to-device operation, one or more devices (each of which may be fixed or mobile) communicate via a direct interface. The direct interface can be a sidelink interface, a PC5 interface, and the like. A device may also be referred to as a user equipment (UE). There are many situations in which determining the location of a UE is necessary. Examples of the situations include placing an emergency call, displaying the UE's location on a map, determining the UE's proximity to a fixed location, and the like. In addition, some use cases call for the location of a first UE to be determined relative to the location(s) of one or more additional UEs; this operation may take the form of ranging or relative positioning. In ranging, the (approximate) distance from a first UE to at least a second UE is determined. In relative positioning, the (approximate) location of the first UE is determined in coordinates relative to the (approximate) location(s) of the additional UE(s). An example of a use case for relative positioning is vehicular platooning, in which the vehicles in the platoon maintain consistent positions relative to one another. Other exemplary use cases include factory-floor applications in which a plurality of devices need to know their positions relative to one another, proximity detection for collision avoidance by vehicles, and the like.

In a general framework for absolute or relative positioning, a first UE, which may be referred to as a “target” UE, may be the object of a positioning operation; that is, the location of the target UE is needed by some requesting entity or entities. The requesting entity may be the target UE itself, a peer UE in a group of UEs communicating via a sidelink interface, a third-party client (e.g., a LoCation Services (LCS) client), a network node or UE including a positioning server functionality, and the like. For a UE in direct correspondence with a cellular network (e.g., operating on a Uu interface), multiple radio access technology (RAT)-dependent positioning methods exist, such as downlink time difference of arrival (DL-TDOA), uplink time difference of arrival (UL-TDOA), multiple round-trip time (multi-RTT), enhanced cell ID (E-CID), and the like; however, for a target UE outside of network coverage and operating in device-to-device communication with other UEs, these methods may not be operable. Such a target UE may rely on using reference signals transmitted on the sidelink interface (by itself, by other UEs, or both), for positioning. These reference signals, which may take various forms, may be referred to generically as sidelink positioning reference signals (SL-PRS), and an operation to compute a position (absolute or relative) based on SL-PRS measurements may be referred to as sidelink positioning.

In various embodiments, sidelink positioning is not restricted to UEs outside of network coverage. In some cases, UEs may need relative location information, such as ranging, that is more naturally computed from sidelink signals than from network-centric signals. (In general, RAT-dependent positioning with a network can provide an absolute position. If the objective of positioning is to estimate the distance between UE A and UE B, it is possible to achieve this objective by determining absolute positions of A and B and computing the distance between them, but it may be quicker and more efficient to estimate the distance directly from signals transmitted between A and B, such as SL-PRS on a sidelink interface.) In addition, measurements for sidelink positioning may be combined with measurements for other positioning methods according to the capabilities of the PCE, allowing hybrid positioning. For example, a PCE might consider both RAT-dependent measurements of signals on a Uu interface and sidelink measurements in computing a location estimate for a target UE.

Throughout this disclosure, we use the term “positioning” to encompass both absolute and relative positioning, and a “location estimate” to encompass an estimated absolute location of a device, an estimated location of a device in coordinates relative to some reference point, and an estimated range of a device to some reference point.

As an example of the approaches described herein, we consider a target UE A, in communication via a sidelink interface with one or more peer UEs, B1, B2, . . . , Bn. Any of the involved UEs may have the capability to transmit SL-PRS and/or the capability to measure SL-PRS transmitted by other UEs. In some embodiments, UE A may include a PCE with the ability to synthesise a location estimate from a suitable set of measurements. In other embodiments, a PCE may be instantiated outside UE A, in which case measurements may need to be transferred to the PCE to be processed into a location estimate.

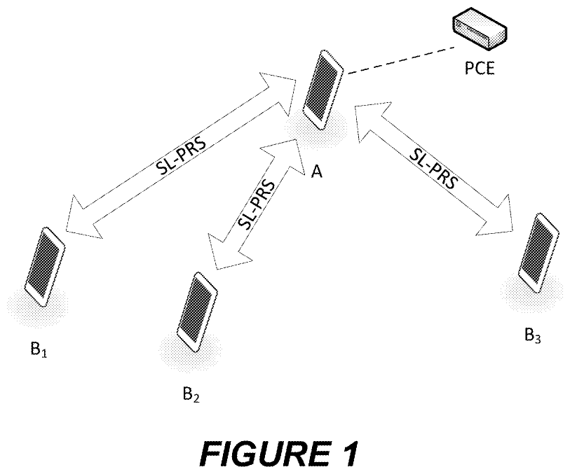

FIG. 1 shows an example of operation by a plurality of UEs in a sidelink environment. In the sidelink environment, SL-PRS are transmitted between UE A and three UEs B1, B2, and B3. UE A has access to a PCE. The PCE may be a function of UE A itself or embodied in an external entity to which UE A has some form of connectivity. It is noted that no cellular network node is shown in the figure; as this omission suggests, the UEs may be operating outside of network coverage and communicating only with one another. Alternatively, one or more of the UEs in the figure may have connectivity to a cellular network (for instance, via a Uu interface). In some cases, the PCE may be located at a node of the cellular network, and the connection shown between UE A and the PCE may be realised by communication with the cellular network.

Positioning methods based on SL-PRS may include various algorithms for determining a location estimate based at least in part on SL-PRS measurements. Some of these algorithms are analogous to but distinct from positioning methods used in the existing art on the Uu interface. As an example, in a procedure analogous to but distinct from DL-TDOA positioning on the Uu interface, UE A may measure the time difference of arrival (TDOA) of SL-PRS transmissions from a pair of UEs Bi, Bj, and determine from the measured TDOA that UE A's (estimated) location lies on a hyperbola with foci at the locations of Bi and Bj. Intersecting the hyperbolae for such TDOA measurements with respect to different pairs of peer UEs yields a location estimate for UE A. As another example, in a procedure analogous to but distinct from UL-TDOA positioning on the Uu interface, UE A may transmit SL-PRS for measurement by the peer UEs Bi. Each Bi may indicate a relative time of arrival (RTOA) of the SL-PRS transmission to the PCE. The PCE may compute corresponding TDOAs that support a similar geometric estimate of UE A's location.

As a third example, in a procedure analogous to but distinct from multi-RTT positioning on the Uu interface, the SL-PRS transmissions described previously may be combined. For example, UE A transmits SL-PRS for measurement by UEs Bi, and UEs Bi also transmit SL-PRS for measurement by UE A. Thus, the various UEs can perform timing measurements and determine receive-transmit (Rx-Tx) time differences, which can be provided to the PCE to be processed into estimates of the round-trip times (RTTs) between the UE pairs (A,Bi). The RTT estimates can be used as a measure of distance, allowing either a direct ranging estimate or a geometric estimation by the PCE of the location of UE A relative to UEs Bi. Other positioning methods based on SL-PRS measurements may be contemplated as well, such as estimating UE A's location based on measurements of SL-PRS timing, signal strength, angle of arrival, and so on.

It is unnecessary and undesirable for all UEs to transmit SL-PRS continuously, which would have costs in interference, bandwidth consumption on the sidelink, and battery usage. Moreover, for a first UE to take measurements of SL-PRS transmissions by a second UE, it is necessary for the first UE to have information about the transmission configuration of the second UE, so that the first UE knows, for example, what signal configuration and/or radio resources to measure. Accordingly, a protocol methodology is sought to coordinate and distribute SL-PRS transmissions and measurements among a target UE (for example, UE A), one or more peer UEs (for example, UEs Bi), and a PCE (which may be located at one of the concerned UEs or elsewhere in the system).

For control of transmissions and measurements between UEs, as well as exchanges of capability information summarising the positioning operations of which the UEs are capable, various sidelink positioning protocols may be developed. In some examples, some sidelink positioning protocols disclosed herein may reuse protocol message formats of related positioning protocols. As one example, aspects of the LTE Positioning Protocol (LPP) as described in 3GPP TS 37.355 may be reused. LPP is designed for communication between a target device and a server, but the protocol model may be adapted to a distributed environment by assigning the server role to one or more of the involved UEs. For example, UE A may function as a server to distribute assistance data regarding its own SL-PRS transmission configuration to UEs Bi so that they can measure UE A's SL-PRS transmissions; on the other hand, each UE Bi may function as a server to distribute, for example, assistance data regarding its own SL-PRS transmission configuration to UE A so that it can measure UE Bi's SL-PRS transmissions.

Similarly, UE A may function as a server to collect measurement results from UEs Bi for delivery to the PCE (which may be located at UE A or elsewhere), and/or one or more of the UEs Bi may function as a server to collect measurement results from UE A and/or other UEs Bj for delivery to the PCE. In some embodiments, the server role may be played by different UEs in different transactions as part of a single positioning operation. In an embodiment, one or more message formats of LPP may be encapsulated and delivered through a control protocol of a sidelink interface, for example, a PC5 signalling (PC5-S) protocol or a PC5 radio resource control (PC5-RRC) protocol.

Alternatively or in addition, aspects of the NR Positioning Protocol A (NRPPa) as described in 3GPP TS 38.455 may be reused. In contrast to LPP, NRPPa does not have abstracted target and server roles; by design, it operates between a location management function (LMF) and a next-generation radio access network (NG-RAN) node. For NRPPa to be applied to a sidelink environment, the protocol would need to be modelled in a more abstract form, e.g., to be terminated between a generically defined “server” and a generically defined “node”, in which the node may be capable of transmitting and/or measuring reference signals for positioning (such as SL-PRS) and the server may be capable of coordinating transmission and measurement operations across a plurality of nodes. In an embodiment, one or more message formats of NRPPa may be encapsulated and delivered through a control protocol of a sidelink interface, for example, a PC5-S protocol or a PC5-RRC protocol.

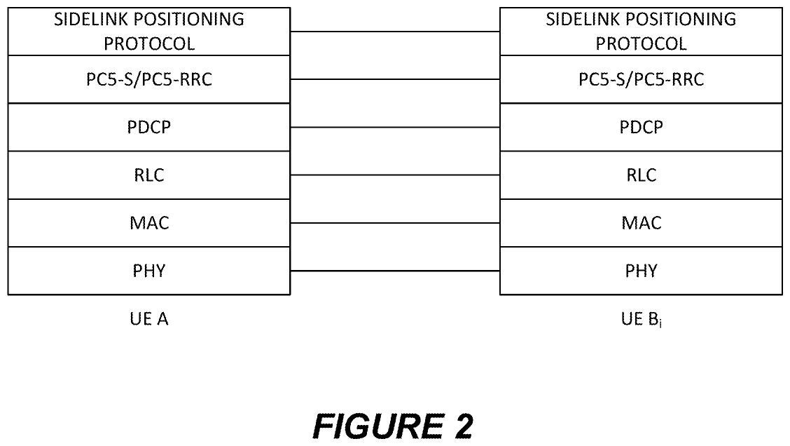

FIG. 2 provides a set of exemplary protocol stacks, with protocols terminated between UE A and UE Bi, for encapsulating sidelink positioning protocol messages inside PC5-S or PC5-RRC. In some examples, the top layer of the stack may include LPP or NRPPa. In some examples, the top layer of the stack may include sidelink positioning protocols different from LPP or NRPPa. This top-layer positioning protocol is encapsulated in the next layer, which may be PC5-S or PC5-RRC. From this second layer down, the stacks are similar to the existing protocol stacks for NR sidelink communication on the PC5 interface, including a packet data convergence protocol (PDCP) layer, a radio link control (RLC) layer, a medium access control (MAC) layer, and a physical (PHY) layer.

In an embodiment, a message format of the top-layer positioning protocol (e.g., LPP or NRPPa) may be contained in an unstructured field, such as an OCTET STRING field of Abstract Syntax Notation 1 (ASN.1), of the next-layer protocol (e.g., PC5-S or PC5-RRC). Such protocol stacks may provide a generic method for delivery of one or more messages of one or more positioning protocols over the sidelink interface. It is noted that transmission of a message of a positioning protocol on the sidelink interface can be facilitated by employment of any such protocol stack, for example, containing various protocols and transport layers.

In one embodiment representing a positioning operation, UE A may request transmission of SL-PRS from one or more UEs Bi. The request may be carried in a first message. The first message may be an LPP Request Assistance Data message or a message of another protocol with similar or different semantics. The first message contains at least a request for an indication of a SL-PRS configuration. The first message may additionally contain one or more parameters indicating characteristics that UE A requests for the SL-PRS transmission from the UEs Bi. The first message may additionally contain an indication of whether UE A requests location information of the UEs Bi (which could be needed, for example, for the PCE to determine an absolute position of UE A). The first message may additionally contain information on the SL-PRS measurement capability of UE A.

One or more of the UEs Bi may reply with a second message containing at least a description of the SL-PRS configuration(s) to be used by the responding UE(s) Bi. The second message may be an LPP Provide Assistance Data message or a message of another protocol with similar or different semantics. The second message may additionally contain location information of the responding UE(s) Bi. If the first message contained parameters indicating requested characteristics of the SL-PRS transmission, the description of the SL-PRS configuration in the second message may or may not align with the parameters. As a result, it is conceivable that one or more UEs Bi transmit a SL-PRS configuration that UE A cannot measure (an example could be a SL-PRS configuration that schedules transmission at a time when UE A cannot monitor the PC5 interface, for instance, due to a scheduled transmission requiring its radio front end to be tuned elsewhere).

These two messages may constitute all or part of a transaction of a sidelink positioning protocol. The protocol can be similar to or different from LPP or NRPPa. After the completion of the protocol transaction, UE A is aware of the expected SL-PRS transmission(s) from UEs Bi, and UE A may take measurements of the SL-PRS transmission(s) and use the measurements as inputs to a positioning calculation. Using the measurements as inputs to a positioning calculation may include delivering the measurements to a PCE. The PCE may be instantiated inside or outside UE A.

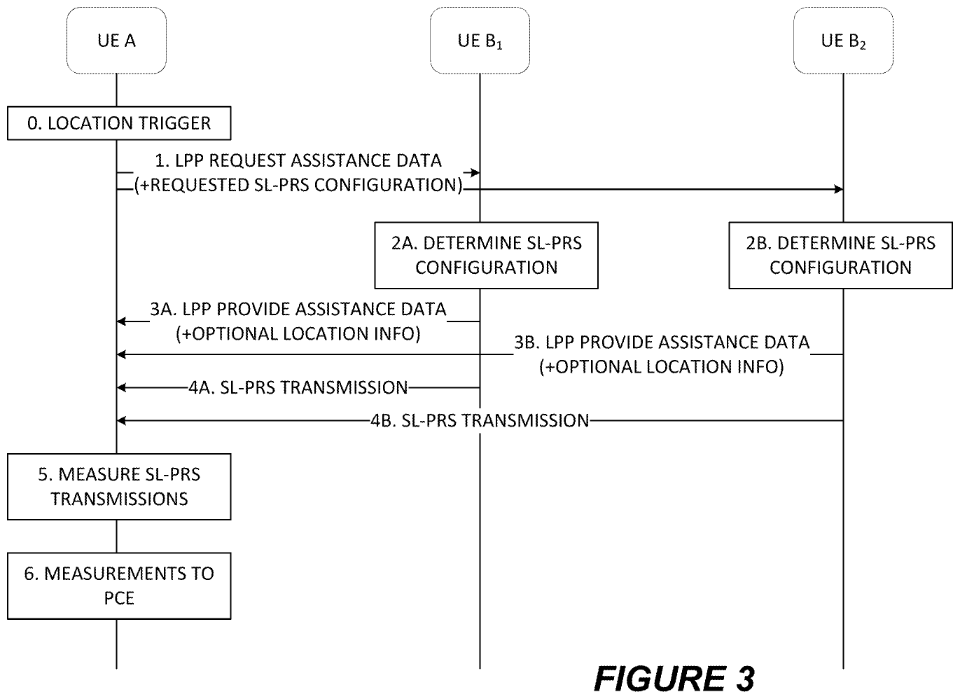

FIG. 3 contains a flow showing a positioning operation as described in the previous paragraph. The operation is shown among a target UE A and two peer UEs B1 and B2, but it should be understood that any number of peer UEs may be involved with similar behaviour. In step 0, a location triggering event occurs, such as a request from upper layers. In step 1 of the figure, UE A transmits a first message—for instance, an LPP Request Assistance Data message—to request SL-PRS transmission. The first message may be transmitted in a broadcast mode, since UE A may not have prior knowledge of all the nearby UEs that can function as peers (and it may be inefficient to send the same request as a multiple-unicast message to many different peer UEs). Alternatively, the first message may be sent to one or more specific peer UEs, using a multicast (or groupcast) or unicast transmission mode.

The first message may contain one or more parameters of a requested SL-PRS configuration (such as a transmission time, preferred time and/or frequency resources, physical layer parameters of the SL-PRS transmission, and the like), shown as “requested SL-PRS configuration” in the figure. The first message may further contain an indication of UE A's capability for SL-PRS measurement. In steps 2a and 2b, UEs B1 and B2 determine their respective SL-PRS configurations for transmission, potentially taking into account any information that was included in the first message. In step 3a, UE B1 transmits a second message—for instance, an LPP Provide Assistance Data message—indicating the SL-PRS configuration it intends to use for transmission, and optionally including information about UE B1's own location. In step 3b, UE B2 transmits a third message—for instance, an LPP Provide Assistance Data message—indicating the SL-PRS configuration it intends to use for transmission, and optionally including information about UE B2's own location.

In steps 4a and 4b, UEs B1 and B2, respectively, transmit SL-PRS according to the configurations determined in the previous steps. In step 5, UE A measures the SL-PRS transmissions. It is noted that UE A may or may not be able to measure all the SL-PRS configurations provided by the peer UEs Bi; in such a case, UE A may be responsible for determining which signals to measure according to its implementation. This situation is further addressed below. In step 6, UE A delivers the SL-PRS measurements from step 5 to the PCE, along with any location information that was included in steps 3a and 3b; as noted previously, the PCE may be a function of UE A itself or located in another entity elsewhere in the system.

As noted above, if the peer UEs Bi determine their DL-PRS configurations independently, the target UE A may not be able to measure all of the resulting transmissions. One way to address this would be to add a facility for coordination among the peer UEs (for example, cross-communication between B1 and B2 to negotiate agreeable configurations at steps 2a and 2b of FIG. 3). Alternatively, UE A may accept or reject the configurations from steps 3a and 3b, indicating in a response message to each peer UE whether it can measure the indicated configuration. Each peer UE may then determine whether it should transmit its SL-PRS in steps 4a/4b.

A similar approach to this coordination problem takes inspiration from NRPPa rather than LPP. UE A may function as a server (the LMF from the NRPPa point of view) and treat the peer UEs Bi as if they were NG-RAN nodes, first configuring and then activating the SL-PRS transmission. The resulting flow is similar to FIG. 3, but the structure in terms of protocol transactions and the encapsulated messages are different. In a first message, UE A may request a SL-PRS configuration from one or more peer UEs Bi, using a first message, similar to the NRPPa Positioning Information Request, and each of the peer UEs may determine independently if it can accept the requested configuration. Each peer UE may then reply with a second message, similar to the NRPPa Positioning Information Response, containing the SL-PRS configuration (if any) that it actually applies. The second message may complete a first transaction of a positioning protocol.

Subsequently, UE A may determine which of the indicated SL-PRS configurations it will actually measure. To each of the peer UEs that offered a congenial SL-PRS configuration, UE A may transmit a third message, similar to the NRPPa Positioning Activation Request message, indicating to the corresponding peer UE that it should activate the proposed SL-PRS transmission. The peer UE may then respond with a fourth message, similar to the NRPPa Positioning Activation Response message, confirming its activation of the SL-PRS transmission. The fourth message may also serve as a trigger to indicate to UE A that it can begin preparations for measurement of the expected SL-PRS. The remainder of the procedure is as shown in FIG. 3.

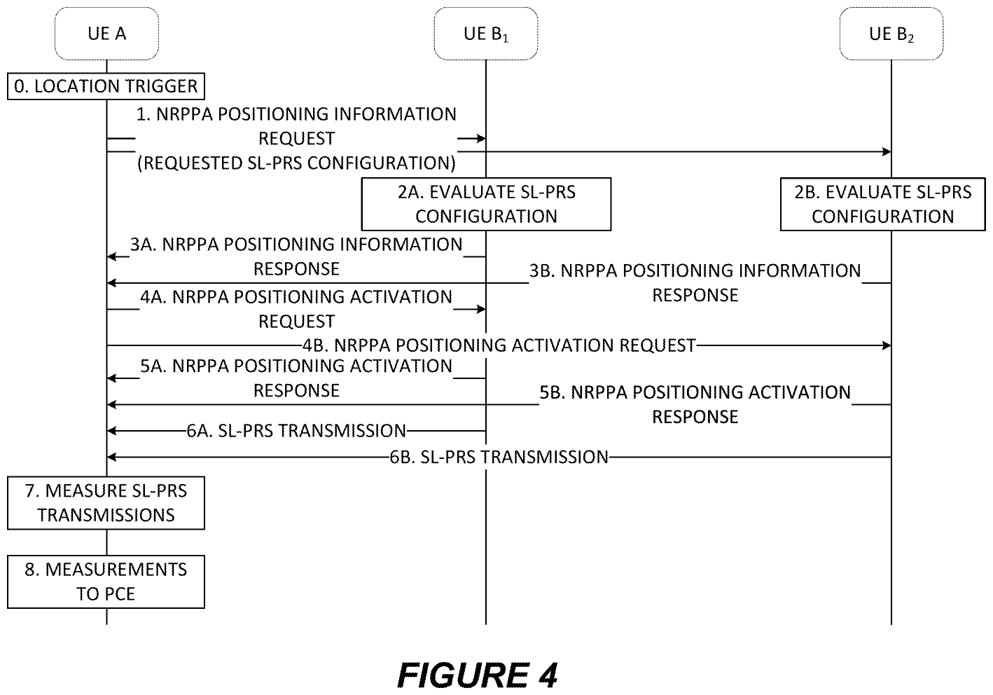

FIG. 4 shows a message flow for the procedure discussed in the preceding paragraph. In step 0, a location triggering event occurs, such as a request from upper layers. In step 1, UE A transmits a first message (for example, an NRPPa Positioning Information Request as shown in the figure), containing the requested SL-PRS configuration parameters. The first message may be transmitted by broadcast or multicast, but in this case all the peer UEs Bi will receive the same requested SL-PRS configuration; accordingly, it may be advantageous for UE A to send the first message separately to each peer UE by unicast. In steps 2a and 2b, the UEs B1 and B2, respectively, evaluate the requested SL-PRS configurations from step 1 and determine to what extent they can or will comply with the request. In steps 3a and 3b, UEs B1 and B2, respectively, transmit a second message (for example, an NRPPa Positioning Information Response as shown in the figure), with each instance of the second message containing the SL-PRS configuration that the transmitting peer UE will actually offer.

UE A can subsequently determine what SL-PRS configurations from among those offered by the peer UEs it will measure; in the example shown in the figure, UE A decides to measure the SL-PRS configurations from both UEs B1 and B2. In steps 4a and 4b, UE A sends to UEs B1 and B2, respectively, a third message (for example, an NRPPa Positioning Activation Request as shown in the figure) indicating that the peer UEs should activate the SL-PRS configurations described in steps 3a and 3b. In steps 5a and 5b, UEs B1 and B2, respectively, confirm the activation of SL-PRS by transmitting a fourth message (for instance, an NRPPa Positioning Activation Response as shown in the figure). Subsequently, in steps 6a and 6b, UEs B1 and B2, respectively, transmit SL-PRS according to their activated configurations. In step 7, UE A measures the SL-PRS transmissions, and in step 8, UE A delivers the measurement results to the PCE.

In another embodiment representing another positioning operation, a target UE A may transmit SL-PRS to be measured by one or more peer UEs Bi. UE A may determine its SL-PRS configuration autonomously and transmit to the peer UEs a first message indicating that the peer UEs should measure the SL-PRS. The first message may contain the SL-PRS transmission configuration. The first message may be an NRPPa Measurement Request or another message with similar or different semantics. The first message may be sent in a blind fashion, in the sense that UE A may not know the configurations or measurement capabilities of the peer UEs before determining its own configuration.

Accordingly, each peer UE Bi may respond in one of two ways: with a second message containing measurement results, or with a third message indicating an inability to measure the configuration. The second message may be an NRPPa Measurement Response message or another message with similar or different semantics; the third message may be an NRPPa Measurement Failure message or another message with similar or different semantics. In some embodiments the third message may be omitted; that is, the peer UEs that can measure the configuration may respond with their measurement results, while the peer UEs that cannot measure the configuration may not respond to UE A at all.

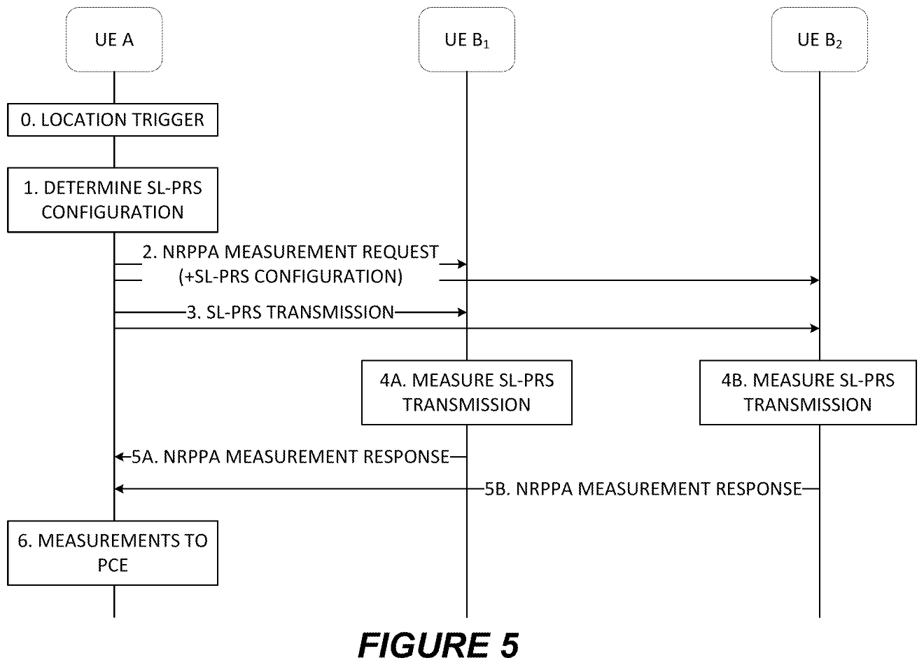

FIG. 5 shows a positioning procedure based on the description above. In step 0, a location triggering event occurs, such as a request from upper layers. In step 1, UE A determines a suitable SL-PRS configuration for its own transmission, which may take into account constraints such as the scheduling of other transmissions, battery power considerations, requirements for transmission on sidelink radio resources, and the like. In step 2, UE A transmits a first message (for instance, an NRPPa Measurement Request as shown in the figure) requesting the peer UEs B1 and B2 to measure the SL-PRS transmission from UE A. The first message may be transmitted by broadcast for the benefit of all nearby peer UEs. Alternatively, the first message may be transmitted separately by unicast to each of UEs B1 and B2. As a third alternative, the first message may be transmitted by multicast to a defined set of peer UEs (for instance, in a vehicular platooning use case, the first message may be directed to all UEs that share a platoon with UE A). The peer UEs B1 and B2 may acknowledge the first message (not shown in the figure).

In step 3, UE A transmits SL-PRS according to the configuration it determined in step 1. In steps 4a and 4b, UEs B1 and B2, respectively, measure the SL-PRS transmission from step 3. In an alternative (not shown in the figure), one or both of UEs B1 and B2 may be unable or unwilling to measure the SL-PRS configuration of UE A, and such a UE may omit the measurement step. In steps 5a and 5b, UEs B1 and B2, respectively, send a second message to UE A. The second message may be an NRPPa Measurement Response message as shown in the figure. Alternatively, the second message may be an NRPPa Measurement Report message, or another protocol message capable of carrying measurement results. In an alternative (not shown in the figure), one or both of UEs B1 and B2 may be unable or unwilling to measure the SL-PRS configuration of UE A, and such a UE may respond with a message indicating a failure (for example, an NRPPa Measurement Failure message). In step 6, UE A delivers the measurement results to the PCE, which as before may be embodied within UE A or elsewhere.

An alternative approach to this “UL-TDOA-like” positioning method may use LPP signalling rather than NRPPa signalling as a foundation. From an LPP protocol perspective, UE A may be considered to function as a server, even though UE A is the device that is ultimately to be positioned. UE A may request measurements from, and provide assistance data to, the peer UEs Bi that perform the measurements, using procedures similar to but potentially different from the LPP procedures. UE A may initiate the positioning operation by transmitting a first message, requesting UEs Bi to perform measurements of SL-PRS transmitted by UE A. The first message may be an LPP Request Location Information message or a similar message that requests positioning measurements. The first message may optionally include an SL-PRS configuration for UE A.

Alternatively, UEs Bi may transmit a second message to UE A to request assistance data for the SL-PRS transmission. The second message may be an LPP Request Assistance Data message or a similar message requesting assistance data. In this alternative, UE A may transmit a third message to UEs Bi to deliver the requested assistance data, which may include a description of UE A's SL-PRS configuration. The third message may be an LPP Provide Assistance Data message or a similar message providing assistance data. After UEs Bi are informed of UE A's SL-PRS configuration (for example, by the first message or by the third message), UE A may transmit SL-PRS for measurement. UEs Bi may measure the transmitted SL-PRS. Subsequent to the measuring, UEs Bi may transmit a fourth message to UE A to convey the measurement results. The fourth message may be an LPP Provide Location Information message or a similar message providing location information in the form of the SL-PRS measurement results. UE A may deliver the measurement results to a PCE.

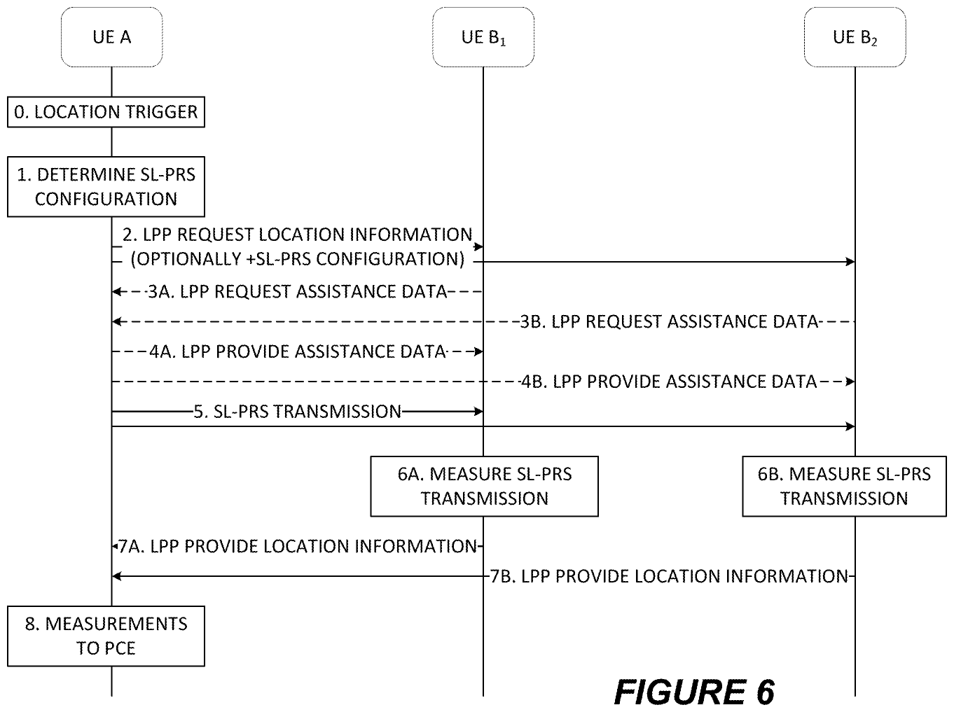

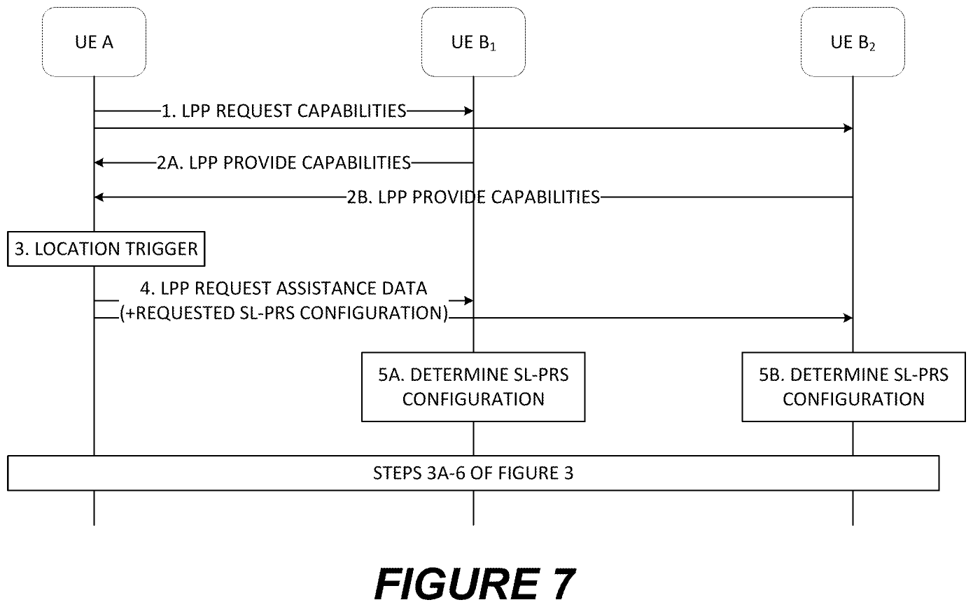

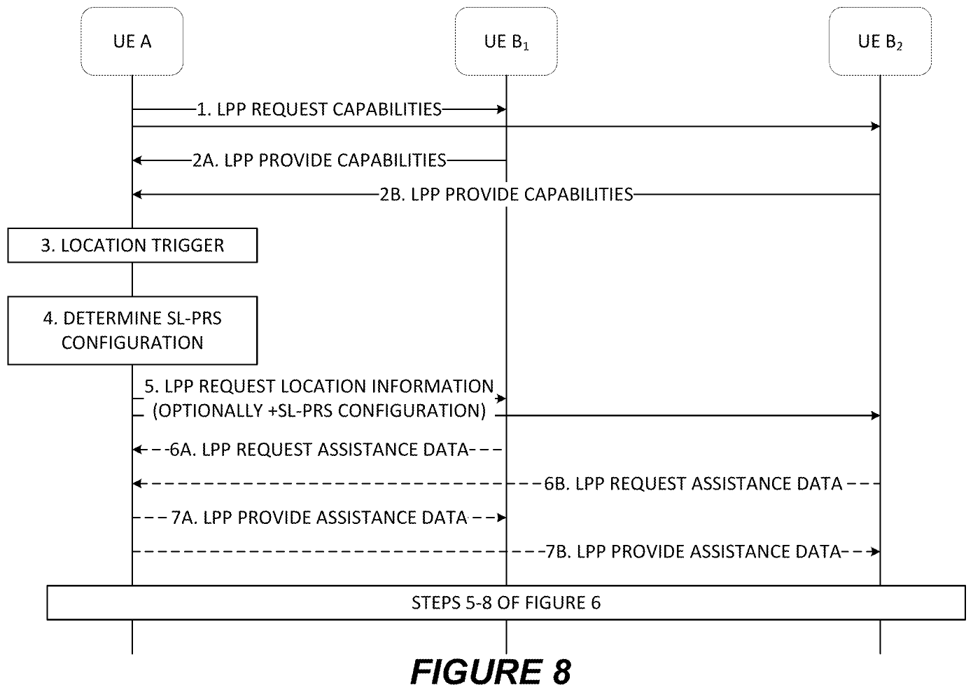

FIG. 6 shows a message flow for a positioning procedure based on the description above. In step 0, a location triggering event occurs, such as a request from upper layers. In step 1, UE A determines a suitable SL-PRS configuration for its own transmission, taking into account various criteria as previously described. In step 2, UE A transmits to UEs B1 and B2 a first message (for example, an LPP Request Location Information message as shown in the figure). The first message may include a request for location information. The first message may include a description of UE A's SL-PRS configuration.

In steps 3a and 3b, UEs B1 and B2, respectively, may transmit to UE A a second message (for example, an LPP Request Assistance Data message as shown in the figure). The second message may include a request for assistance data. The requested assistance data may include a description of the SL-PRS configuration. In steps 4a and 4b, UE A may transmit to UEs B1 and B2 a third message (for example, an LPP Provide Assistance Data message as shown in the figure). The third message may include assistance data, including, for example, a description of UE A's SL-PRS configuration. Steps 3a-4b may be necessary if the first message (step 2) did not contain a description of the SL-PRS configuration.

In step 5, UE A transmits SL-PRS according to the configuration it determined in step 1. In steps 6a and 6b, UEs B1 and B2, respectively, measure the transmitted SL-PRS from UE A. In steps 7a and 7b, UEs B1 and B2, respectively, transmit to UE A a fourth message (for example, an LPP Provide Location Information message as shown in the figure). The fourth message may include location information, including, for example, the measurement results derived in steps 6a and 6b. In step 8, UE A delivers the measurement results to a PCE, which may be embodied in UE A or elsewhere.

In some embodiments, the first and third messages of FIG. 6 may be combined. For example, a single transmission between UE A and UEs B1 and B2 may contain both an LPP Request Location Information message (or another message with similar or different semantics) and an LPP Provide Assistance Data message (or another message with similar or different semantics). These two messages may, for example, be encapsulated as separate protocol data units (PDUs) in a message of a lower-layer protocol (such as PC5-S, PC5-RRC, and the like). In this case, the second message of FIG. 6 (steps 3a and 3b) may be unnecessary.

In any of the foregoing embodiments, some of the participating UEs may need to be aware of one another's capabilities. For example, in selecting a suitable SL-PRS configuration for transmission, a transmitter UE may need to know the reception and/or measurement capabilities of one or more receiver UEs, so that it does not send SL-PRS in a configuration that the receiver UEs cannot measure. Such a transmitter UE may request capability information from the corresponding receiver UEs. On the other hand, when a receiver UE sends a requested SL-PRS configuration to one or more transmitter UEs, the receiver UE may need to know the transmission capabilities of the transmitter UEs, so that it does not request an SL-PRS transmission configuration with which the transmitter UEs cannot comply. Such a receiver UE may request capability information from the corresponding transmitter UEs.

FIG. 7 shows how an exchange of capabilities may be integrated into a positioning procedure similar to FIG. 3. In step 1, UE A transmits to UEs B1 and B2 a first message (for example, an LPP Request Capabilities message as shown in the figure). The first message may be transmitted by broadcast, multicast, or unicast. The first message may contain an indication that specific capabilities, such as capabilities related to SL-PRS transmission, are requested. In steps 2a and 2b, UEs B1 and B2, respectively, transmit to UE A a second message (for example, an LPP Provide Capabilities message as shown in the figure). The second message may contain information about the capabilities of the transmitting UE (B1 or B2). The second message may contain a subset of capabilities conforming to the capabilities that were requested in the first message.

After steps 2a and 2b, UE A is informed of the capabilities of UEs B1 and B2, and UE A may be able to compose an appropriate SL-PRS configuration to request later in the procedure. It is noted that these steps may occur as part of a positioning procedure, for example, after a triggering event such as an application-layer request for location information. Or, these steps may occur independent of any positioning procedure, for example, as a way for UE A to inform itself of the capabilities of neighbouring peer UEs before any positioning operation is attempted.

In step 3, a location triggering event occurs, such as a request from upper layers; as noted above, this step may occur either before or after steps 1, 2a, and 2b. In step 4, UE A transmits to UEs B1 and B2 a third message (for example, an LPP Request Assistance Data message as shown in the figure). The third message may contain a request for assistance data such as an SL-PRS configuration. The third message may contain one or more parameters of a requested SL-PRS configuration. The third message may be sent by broadcast or multicast if UE A intends to request the same SL-PRS configuration from all peer UEs; alternatively, the third message may be sent by unicast to each of UEs B1 and B2, allowing UE A to request different SL-PRS configurations from UEs B1 and B2 according to their respective capabilities.

It is noted that UE A may request a particular SL-PRS configuration, taking into account the capabilities of UEs B1 and B2 to transmit SL-PRS, but UEs B1 and B2 may have other constraints or preferences that affect the SL-PRS configuration(s) they actually use. Thus, in steps 5a and 5b, UEs B1 and B2, respectively, determine their own SL-PRS configurations, considering the requested configuration from step 4 as well as any other constraints or preferences. Subsequent to steps 5a and 5b, the procedure may follow steps 3a through 6 of FIG. 3, which describe the transmission and measurement of SL-PRS and the delivery of measurement results to the PCE.

FIG. 8 shows how an exchange of capabilities may be integrated into a positioning procedure similar to FIG. 6. In step 1, UE A transmits to UEs B1 and B2 a first message (for example, an LPP Request Capabilities message as shown in the figure). The first message may be transmitted by broadcast, multicast, or unicast. The first message may contain an indication that specific capabilities, such as capabilities related to SL-PRS reception and/or measurement, are requested. In steps 2a and 2b, UEs B1 and B2, respectively, transmit to UE A a second message (for example, an LPP Provide Capabilities message as shown in the figure). The second message may contain information about the capabilities of the transmitting UE (B1 or B2). The second message may contain a subset of capabilities conforming to the capabilities that were requested in the first message. After steps 2a and 2b, UE A is informed of the capabilities of UEs B1 and B2, and UE A may be able to compose an appropriate SL-PRS configuration for its own transmission later in the procedure. It is noted that these steps may occur as part of a positioning procedure, for example, after a triggering event such as an application-layer request for location information. Or, these steps may occur independent of any positioning procedure, for example, as a way for UE A to inform itself of the capabilities of neighbouring peer UEs before any positioning operation is attempted.

In step 3, a location triggering event occurs, such as a request from upper layers; as noted above, this step may occur either before or after steps 1, 2a, and 2b. In step 4, UE A determines an SL-PRS configuration to be used for its own transmission later in the procedure. In step 5, UE A transmits to UEs B1 and B2 a third message (for example, an LPP Request Location Information message as shown in the figure). The third message may be transmitted by broadcast, multicast, or unicast. The third message may contain a request for location information, such as measurements of an SL-PRS transmission. The third message may further contain information about UE A's selected SL-PRS configuration. In steps 6a through 7b, an optional exchange of messages allows UEs B1 and B2 to obtain assistance data describing UE A's selected SL-PRS configuration in case they were not informed of it in step 4; these steps are analogous to steps 3a through 4b of FIG. 6. Subsequent to the described steps, the procedure may follow steps 5 through 8 of FIG. 6, which describe the transmission and measurement of SL-PRS and the delivery of measurement results to UE A and onward to the PCE.

It is noted that FIGS. 7 and 8 integrate the LPP capability exchange framework into procedures already based on LPP signalling. In alternative procedures based on NRPPa signalling (e.g., FIGS. 4 and 5), there may be a need for the involved devices to exchange capabilities, for the same reasons as previously described. Similar adaptations of the message flows allow UE A to obtain the capabilities of the peer UEs Bi in such cases, e.g., by sending a capability request and receiving one or more capability responses at the beginning of each procedure. In some embodiments, the capability request may be an LPP Request Capabilities message and/or the capability response may be an LPP Provide Capabilities message. Alternatively, the capability request may be a new capability request message of NRPPa or another protocol, and/or the capability response may be a new capability response message of NRPPa or another protocol.

The procedures described above support “DL-like” and “UL-like” positioning operations, with message flows analogous to but distinct from DL-TDOA and UL-TDOA respectively. The case of multi-RTT positioning can be considered separately since it combines elements of both models. On the Uu interface, multi-RTT positioning combines DL-PRS measurements taken at a UE with uplink sounding reference signal (UL-SRS) measurements taken at a plurality of NG-RAN nodes to determine an estimate of the RTT between the UE and each NG-RAN node; these RTT estimates can then be geometrically combined to provide a location estimate according to well-known methods.

To apply a similar operation on a sidelink interface, a PCE can collect SL-PRS measurements taken at a target UE (“DL-like”) and SL-PRS measurements taken at a plurality of peer UEs (“UL-like”). The PCE can combine the measurements to determine an estimate of the RTT between the target UE and each peer UE. The PCE can apply similar geometric methods to convert these RTT estimates to a location estimate. It is noted that, as with other positioning methods, the PCE may need to know the locations (to some level of accuracy) of the peer UEs in order to produce an absolute positioning result for the target UE. Therefore, the locations of the peer UEs may need to be delivered along with the SL-PRS measurement results taken by the peer UEs.

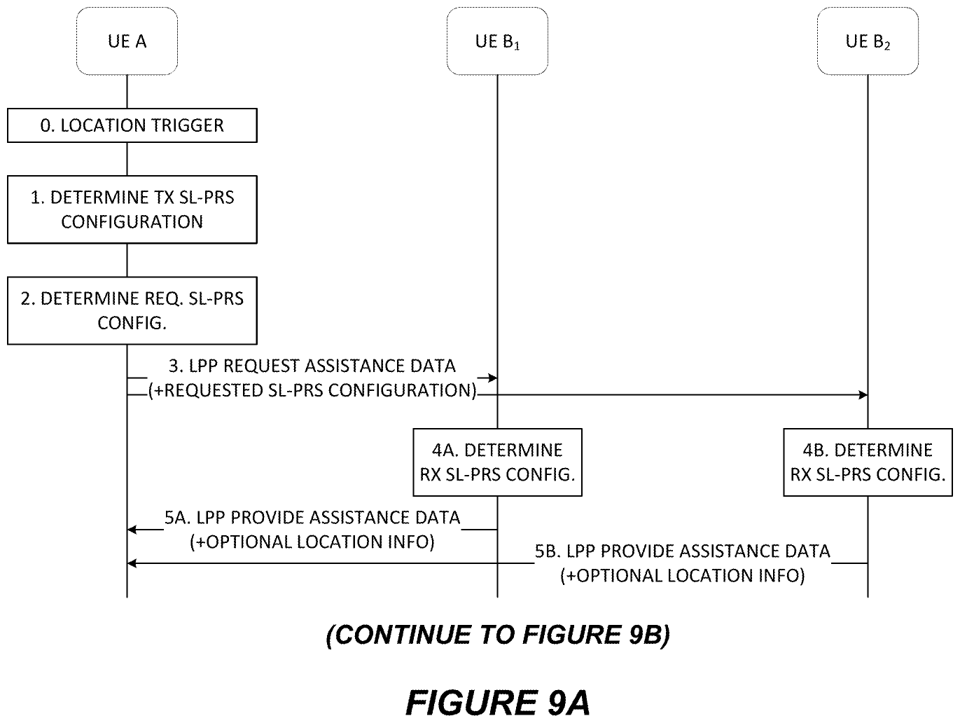

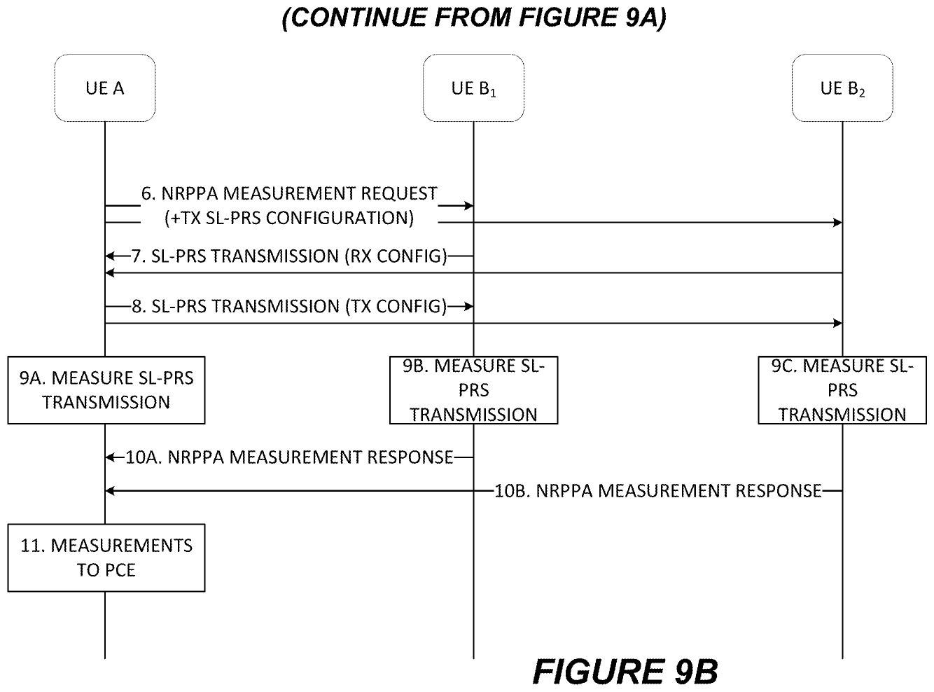

FIGS. 9A-9B shows a message flow for multi-RTT positioning on a sidelink interface, in the case where the measurements are collected by the target UE (UE A in the figure) for delivery to the PCE. (In other embodiments, the measurements may be delivered directly to the PCE from the UEs that take them.) The exemplary flow combines elements of the LPP and NRPPa protocols, but it should be understood that various specific messages may be used, incorporating aspects of any of the procedures described above.

In step 0, a location triggering event occurs, such as a request from upper layers. In step 1 of FIG. 9A, UE A (the target UE) determines an SL-PRS configuration for transmission, referred to in the figure as the “Tx SL-PRS configuration”. (It should be appreciated that at any time before the procedure shown here, the involved UEs may have exchanged capabilities using the procedures described previously, so UEs A, B1, and B2 may be aware of one another's transmission, reception, and/or measurement capabilities.) In step 2, UE A may determine an SL-PRS configuration to be requested for reception, referred to in the figure as the “requested SL-PRS configuration”. Step 2 may be optional, in which case UE A relies on the peer UEs to generate their own SL-PRS configurations.

In step 3, UE A transmits to UEs B1 and B2 a first message (for instance, an LPP Request Assistance Data message as shown in the figure). The first message may be transmitted by broadcast, multicast, or unicast. The first message may contain the requested SL-PRS configuration from step 2, if step 2 occurred. In steps 4a and 4b, UEs B1 and B2 determine the SL-PRS configurations that they will transmit, referred to in the figure as the “Rx SL-PRS configuration”. This name is based on the fact that these configurations will be received (“Rx”) by UE A. UEs B1 and B2 may consider any requested configuration from UE A in generating the Rx SL-PRS configuration. It is noted that UEs B1 and B2 may generate different Rx SL-PRS configurations, each according to its own capability, preferences, and/or constraints; for brevity, the figure is drawn as if there were a single Rx SL-PRS configuration. In steps 5a and 5b, UEs B1 and B2 transmit to UE A a second message (for example, an LPP Provide Assistance Data message as shown in the figure). The second message may contain a description of the Rx SL-PRS configuration (this is the assistance data requested by the first message). The second message may further contain location information of the peer UEs B1 and B2.

In FIG. 9B, in step 6, UE A transmits to UEs B1 and B2 a third message (for example, an NRPPa Measurement Request as shown in the figure). In an alternative embodiment, the third message may be an LPP Request Location Information message. In another alternative embodiment, the third message may include two separate messages (for example, as two separately encapsulated PDUs), such as an LPP Provide Assistance Data message (describing the Tx SL-PRS configuration) followed by an LPP Request Assistance Data message (requesting measurements). The third message may contain a description of the Tx SL-PRS configuration. After step 6, UE A is aware of the Rx SL-PRS configuration(s) that will be used for transmission by UEs B1 and B2, and UEs B1 and B2 are aware of the Tx SL-PRS configuration that will be used for transmission by UE A.

In step 7, UEs B1 and B2 transmit SL-PRS according to the Rx SL-PRS configurations. In step 8, UE A transmits SL-PRS according to the Tx SL-PRS configuration. In steps 9a, 9b, and 9c, UEs A, B1, and B2 measure the respective SL-PRS transmissions; that is, UE A measures the transmissions on the Rx SL-PRS configurations, and UEs B1 and B2 measure the transmission on the Tx SL-PRS configuration. It is desirable that steps 9a, 9b, and 9c occur as close to simultaneously as possible, because the time-based measurements from these steps will be combined in the PCE; accordingly, the messages delivering the SL-PRS configurations (for example, the messages in steps 3 and 6) may contain timing information to control when the SL-PRS are transmitted and when the measurements are taken. In steps 10a and 10b, UEs B1 and B2 transmit to UE A a fourth message (for example, an NRPPa Measurement Response message as shown in the figure) including the results of the measurements in steps 9b and 9c. After steps 10a and 10b, UE A has collected all the measurements of the Tx and Rx SL-PRS configurations. In step 11, UE A delivers the measurements to the PCE, which, as in the previously described procedures, may be instantiated in UE A or elsewhere.

Considering the procedures described above, a sidelink protocol operating between a target UE and one or more peer UEs on a sidelink interface may need to include some or all of the following operations:
Exchange of capabilities: A first UE sends a first (request) message to a second UE, and the second UE sends a second (response) message to the first UE. This procedure is analogous to the LPP capability exchange.
Request for measurements: A first UE sends a first (request) message to a second UE, and the second UE may send a second (response) message to the first UE containing one or more measurement results. Alternatively (for example, if a measurement attempt failed or the second UE was unable to comply with a measurement configuration), the second UE may send a third (failure) message to the first UE.
Request for assistance data: A first UE sends a first (request) message to a second UE, and the second UE may send a second (response) message to the first UE containing assistance data, such as a description of a SL-PRS configuration. The second message may contain an error indication, for example, if some or all of the requested assistance data are not available from the second UE.
Activation of a transmission configuration: A first UE sends a first (activation) message to a second UE, and the second UE may send a second (response) message to the first UE confirming its intention to activate a transmission configuration. The second message may contain an error indication, for example, if the second UE is unable to activate the transmission configuration at the requested time.

These operations may be considered as elementary procedures of a protocol, as transaction types of a protocol, and the like. It is noted that the described functionalities resemble but are distinct from existing operations of the LPP and NRPPa protocols (respectively, the LPP capability request procedure, the LPP location information procedure or the NRPPa measurement request procedure, the LPP assistance data retrieval procedure, and the NRPPa activation procedure), and messages of these protocols may accordingly be adapted to the functions described herein.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

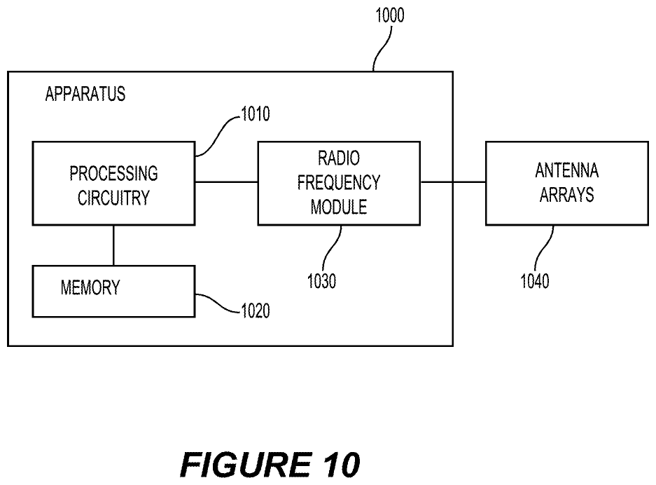

FIG. 10 shows an apparatus 1000 according to embodiments of the disclosure. The apparatus 1000 can be configured to perform various functions in accordance with one or more embodiments or examples described herein. Thus, the apparatus 1000 can provide means for implementation of mechanisms, techniques, processes, functions, components, systems described herein. For example, the apparatus 1000 can be used to implement functions of UEs in various embodiments and examples described herein. The apparatus 1000 can include a general-purpose processor or specially designed circuits to implement various functions, components, or processes described herein in various embodiments. The apparatus 1000 can include processing circuitry 1010, a memory 1020, and a radio frequency (RF) module 1030.

In various examples, the processing circuitry 1010 can include circuitry configured to perform the functions and processes described herein in combination with software or without software. In various examples, the processing circuitry 1010 can be a digital signal processor (DSP), an application-specific integrated circuit (ASIC), programmable logic devices (PLDs), field programmable gate arrays (FPGAs), digitally enhanced circuits, or comparable device or a combination thereof.

In some other examples, the processing circuitry 1010 can be a central processing unit (CPU) configured to execute program instructions to perform various functions and processes described herein. Accordingly, the memory 1020 can be configured to store program instructions. The processing circuitry 1010, when executing the program instructions, can perform the functions and processes. The memory 1020 can further store other programs or data, such as operating systems, application programs, and the like. The memory 1020 can include non-transitory storage media, such as a read-only memory (ROM), a random-access memory (RAM), a flash memory, a solid-state memory, a hard disk drive, an optical disk drive, and the like.

In an embodiment, the RF module 1030 receives a processed data signal from the processing circuitry 1010 and converts the data signal to beamforming wireless signals that are then transmitted via antenna arrays 1040, or vice versa. The RF module 1030 can include a digital to analog converter (DAC), an analog to digital converter (ADC), a frequency up converter, a frequency-down converter, filters and amplifiers for reception and transmission operations. The RF module 1030 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 1040 can include one or more antenna arrays.

The apparatus 1000 can optionally include other components, such as input and output devices, additional or signal processing circuitry, and the like. Accordingly, the apparatus 1000 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer-readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random-access memory (RAM), a read-only memory (ROM), a magnetic disk and an optical disk, and the like. The computer-readable non-transitory storage medium can include all types of computer-readable medium, including magnetic storage medium, optical storage medium, flash medium, and solid-state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

Reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, comprising:
transmitting, on a sidelink interface from a first user equipment (UE) to a second UE, a first message including a request for a first reference signal configuration;
receiving, on the sidelink interface, at the first UE from the second UE, a second message including a second reference signal configuration, the second reference signal configuration being the same as or different from the first reference signal configuration;
measuring, at the first UE, a reference signal transmitted from the second UE based on the second reference signal configuration received from the second UE to produce a measurement result; and
delivering the measurement result to a position calculation entity (PCE).

2. The method of claim 1, wherein the first message further includes a description of the first reference signal configuration.

3. The method of claim 1, wherein the second message further includes location information of the second UE.

4. The method of claim 3, wherein the delivering includes:
delivering the location information of the second UE to the PCE.

5. The method of claim 1, further comprising:
transmitting, on the sidelink interface to the second UE, subsequent to the receiving the second message and prior to the measuring the reference signal, a third message including an activation instruction for transmitting the reference signal from the second UE.

6. The method of claim 5, further comprising:
receiving a fourth message from the second UE confirming reception of the activation instruction.

7. The method of claim 1, further comprising:
transmitting, on the sidelink interface to the second UE, a fifth message including a request for positioning capabilities of the second UE; and
receiving, on the sidelink interface from the second UE, a sixth message including a description of at least a subset of all positioning capabilities of the second UE.

8. The method of claim 7, wherein the request for positioning capabilities of the second UE in the fifth message includes a description of requested positioning capabilities that the second UE may or may not have.

9. The method of claim 8, wherein the at least a subset of all positioning capabilities of the second UE in the sixth message is a subset of the requested positioning capabilities in the fifth message.

10. A method, comprising:
transmitting, on a sidelink interface from a first user equipment (UE) to a second UE, a first message requesting a measurement of a reference signal that is transmitted from the first UE based on a reference signal configuration;
transmitting, on the sidelink interface from the first UE, the reference signal based on the reference signal configuration;
receiving, on the sidelink interface from the second UE at the first UE, a second message including a measurement result of the reference signal transmitted from the first UE; and
delivering the measurement result to a positioning calculation entity (PCE).

11. The method of claim 10, wherein the first message includes a description of the reference signal configuration.

12. The method of claim 10, further comprising:
receiving, on the sidelink interface from the second UE, a third message including a request for a description of the reference signal configuration; and
transmitting, on the sidelink interface to the second UE, a fourth message including the description of the reference signal configuration.

13. The method of claim 10, wherein the first message includes an LTE Positioning Protocol (LPP) Request Location Information message.

14. A method, comprising:
transmitting, on a sidelink interface from a first user equipment (UE) to a second UE, a first message including a request for a first reference signal configuration corresponding to a first reference signal;
transmitting, on the sidelink interface from the first UE to the second UE, a second message including a request for measurement of a second reference signal transmitted from the first UE based on a second reference signal configuration;
receiving, on the sidelink interface from the second UE at the first UE, a third message including a description of a third reference signal configuration, the third reference signal configuration being the same as or different from the first reference signal configuration;
measuring the first reference signal transmitted from the second UE based on the third reference signal configuration at the first UE to produce a first measurement result;
transmitting, on the sidelink interface from the first UE, the second reference signal based on the second reference signal configuration;
receiving, on the sidelink interface from the second UE at the first UE, a fourth message including a second measurement result of the second reference signal produced at the second UE; and
delivering the first measurement result and the second measurement result to a positioning calculation entity (PCE).

15. The method of claim 14, wherein the first message includes a description of the first reference signal configuration.

16. The method of claim 14, wherein the third message includes location information of the second UE, and the delivering includes delivering the location information of the second UE to the PCE.

17. The method of claim 14, wherein the first message includes an LTE Positioning Protocol (LPP) Request Assistance Data message.

18. The method of claim 14, wherein the second message includes an NR Positioning Protocol A (NRPPa) Measurement Request message.

19. The method of claim 14, wherein the third message includes an LPP Provide Assistance Data message.

20. The method of claim 14, wherein the fourth message includes an NRPPa Measurement Response message.
